(19) United States
(12) Patent Application Publication
(10) Pub. No.: US 2023/0259441 A1
(43) Pub. Date: Aug. 17, 2023

(54) FAST TRAINING FOR A DATA PIPELINE MONITORING SYSTEM

(71) Applicant: Data Culpa, Inc., Carlisle, MA (US)

(72) Inventor: J. Mitchell Haile, Carlisle, MA (US)

(21) Appl. No.: 18/170,383

(22) Filed: Feb. 16, 2023

Related U.S. Application Data
(60) Provisional application No. 63/311,365, filed on Feb. 17, 2022.

(51) Int. Cl. G06F 11/34; G06F 11/07

(52) U.S. Cl. CPC G06F 11/3457; G06F 11/0766; G06F 2201/81

(57) ABSTRACT

Various embodiments comprise systems and methods to determine output attributes of a data pipeline. In some examples, a data pipeline monitoring system retrieves historical data generated by a data pipeline and determines generation dates for the historical outputs. The system identifies one or more attributes of the historical data outputs. The system generates an output model that indicates expected output attributes based on the identified attributes of the historical outputs. The system generates an error threshold based on the model and applies the error threshold to outputs generated by the data pipeline. The system generates alerts when the outputs trigger the error threshold.

### RELATED APPLICATIONS

This U.S. patent application claims priority to U.S. Provisional Patent Application 63/311,365 entitled “FAST TRAINING FOR A DATA PIPELINE MONITORING SYSTEM” which was filed on Feb. 17, 2022, and which is incorporated by reference into this U.S. patent application in its entirety.

### TECHNICAL BACKGROUND

A data pipeline comprises a series of data processing elements aligned in series. A data pipeline ingests data from a data source. The processing elements of the pipeline process the input data in series to achieve a desired effect. The data pipelines transfer the processed data to target destinations as data outputs. Data pipelines are configured to intake data that comprises a known format for their data processing elements to operate accurately. When the input data to a data pipeline is altered, the data processing elements may not recognize the changes which causes malfunctions in the operation of the data pipeline. Changes to input data like schema changes, schema creep, and typographical errors often arise when the data sets are large results in variety of technical issues when processing or ingesting data through a data pipeline. Completeness issues can also arise and cause problems in the data pipelines. For example, completeness can be compromised when there is an incorrect count of data rows/documents, there are missing fields or missing values, and/or there are duplicate and near-duplicate data entries. Additionally, accuracy issues in pipeline inputs may arise when there are incorrect types in fields. For example, a string field that often comprises numbers is altered to now comprise words resulting in a malfunction of the processing operations of the data pipeline. Computing glitches can arise in data pipelines which adversely impact data quality and are difficult to debug.

Data pipeline monitoring systems are employed to counteract the range of technical issues that occur with data pipelines. Data pipeline monitoring systems monitor a data pipeline to track when errors occur within the data pipeline. Before a data pipeline monitoring system can operate on a given data pipeline, the pipeline monitoring system must be trained to operate on that pipeline. During training, the data pipeline monitoring system is coupled to the data pipeline and observes the inputs, outputs, and processing operations of the pipeline to determine an operational baseline. This training period takes an extended period of time, as long as three weeks, which delays the deployment of the monitoring system. Unfortunately, data pipeline monitoring systems do not effectively and efficiently train themselves to monitor data pipelines.

### Overview

This Overview is provided to introduce a selection of concepts in a simplified form that are further described below in the Detail Description. This summary is not intended to identify key features or essential features of the claimed subject matter, nor is it intended to be used as an aid in determining the scope of the claimed subject matter.

Various embodiments of the present technology generally relate to solutions for training data pipeline systems. Some embodiments comprise a data pipeline monitoring system to determine output attributes for a data pipeline. The data pipeline system comprises a memory that stores executable components and a processor operatively coupled to the memory that executes the executable components. The executable components comprise a data ingestion component, a training component, and a monitoring component. The data ingestion component retrieves historical data outputs generated by a data pipeline and determines generations dates for individual ones of the historical data outputs. The training component identifies one or more attributes of the historical data outputs and generates an output model that indicates one or more expected output attributes based on the one or more identified attributes of the historical data outputs. The training component generates an error threshold based on the output model. The monitoring component applies the error threshold to an output generated by the data pipeline and generates an alert when the output generated by the data pipeline triggers the error threshold.

Some embodiments comprise a method of operating a data pipeline monitoring system to determine output attributes of a data pipeline. The method includes retrieving historical data outputs generated by the data pipeline and determining generation dates for individual ones of the historical data outputs. The method further includes identifying one or more attributes of the historical data outputs and generating an output model that indicates one or more expected output attributes based on the one or more identified attributes. The method further includes generating an error threshold based on the output model, applying the error threshold to an output generated by the data pipeline, and generating an alert that indicates the output when the output generated by the data pipeline triggers the error threshold.

Some embodiments comprise a non-transitory computer-readable medium storing instructions to determine output attributes of a data pipeline. The instructions, in response to execution by one or more processors, cause the one or more processors to drive a system to perform pipeline monitoring operations. The operations comprise retrieving historical data outputs generated by the data pipeline. The operations further comprise determining generation dates for individual ones of the historical data outputs. The operations further comprise identifying one or more attributes of the historical data outputs. The operations further comprise generating an output model that indicates one or more expected output attributes based on the one or more identified attributes. The operations further comprise generating an error threshold based on the output model. The operations further comprise applying the error threshold to an output generated by the data pipeline. The operations further comprise generating an alert that indicates the output when the output generated by the data pipeline triggers the error threshold.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary data pipeline monitoring system.

FIG. 2 illustrates an exemplary operation of a data pipeline monitoring system.

FIG. 3 illustrates an exemplary data pipeline monitoring system.

FIG. 4 illustrates an exemplary operation of a data pipeline monitoring system.

FIG. 5 illustrates an exemplary user interface system.

FIG. 6 illustrates an exemplary user interface system.

FIG. 7 illustrates an exemplary user interface system.

FIG. 8 illustrates an exemplary user interface system.

FIG. 9 illustrates an exemplary computing device that may be used in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Various embodiments of the present technology relate to solutions for monitoring the operations of data pipeline systems. More specifically, embodiments of the present technology relate to systems and methods for efficiently training data pipeline monitoring systems to detect when errors occur in data pipelines. In the examples presented herein, a data pipeline monitoring system is operatively coupled to a data pipeline and a data target. The data target receives, and stores data outputs generated by the data pipeline. As the data pipeline operates, the data target builds a catalogue of data outputs forming a historical data set that characterizes the operation of the data pipeline over time. To initiate the training process, the data pipeline monitoring system queries the data target to retrieve the historical data. The data monitoring system determines attributes for the outputs that comprise the historical data. The determined attributes include output size, data type, schema, data value distribution, average data value, probability distributions for the output, and/or other types of data attributes. The monitoring circuitry additionally determines the dates of generation for the outputs that form the historical data set. The data monitoring system correlates the determined attributes for the outputs with the generation dates to build a model of how the data pipeline operates over time. The data monitoring circuitry compares the operations of the data pipeline to the model and detects when the data pipeline deviates from historical operating norms based on the comparison. By training the pipeline monitoring system using readily available historical data, training times are greatly reduced when compared to traditional pipeline monitoring systems. For example, the exemplary data pipeline monitoring systems presented herein may be trained in as little as 30 minutes, far less than traditional training methods which take as long as three weeks. The reduced training time increases the efficiency in which the monitoring system may be deployed to monitor the operations of a data pipeline. The increased efficiency allows for pipeline monitoring systems described herein to begin monitoring a data pipeline faster than traditional monitoring systems. Now referring to the Figures.

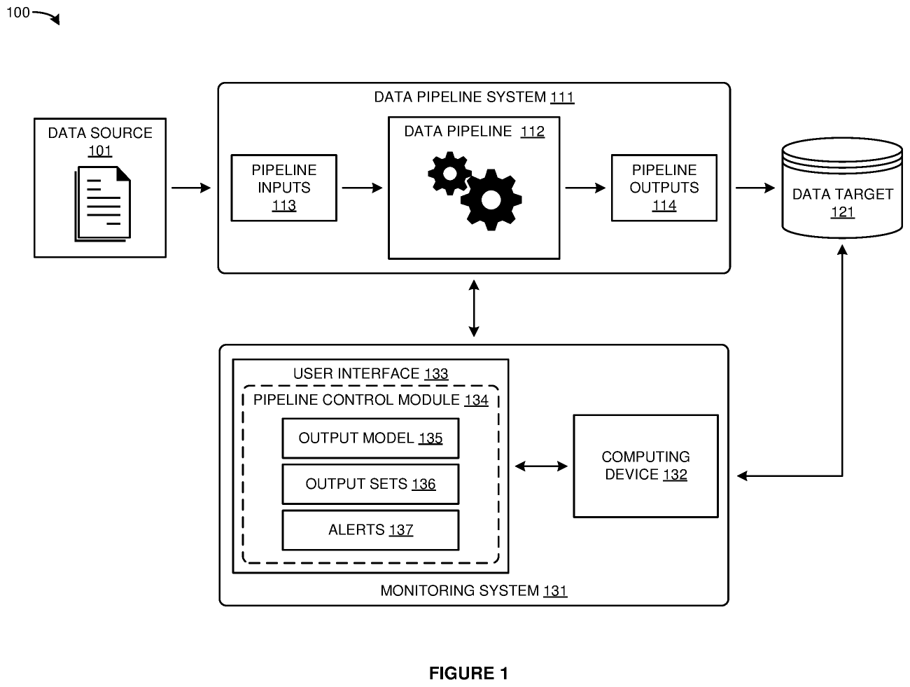

FIG. 1 illustrates data processing environment 100 to monitor operations of a data pipeline. Data processing environment 100 processes raw data generated by data sources into a processed form for use in data analytics, data storage, data harvesting, and the like. Data processing environment 100 comprises data source 101, data pipeline system 111, data target 121, and monitoring system 131. Data pipeline system 111 comprises data pipeline 112, pipeline inputs 113, and pipeline outputs 114. Monitoring system 131 comprises computing device 132, user interface 133, pipeline control module 134, output model 135, output sets 136, and alerts 137. Computing device 132 may host and execute applications like data ingestion modules, training modules, and monitoring modules to drive the application of monitoring system 131. In other examples, data processing environment 100 may include fewer or additional components than those illustrated in FIG. 1. Likewise, the illustrated components of data processing environment 100 may include fewer or additional components, assets, or connections than shown. Each of data source 101, data pipeline system 111, data target 121, monitoring and/or system 131 may be representative of a single computing apparatus or multiple computing apparatuses.

Data source 101 is operatively coupled to data pipeline system 111. Data source 101 is representative of one or more systems, apparatuses, computing devices, and the like that generate raw data for consumption by data pipeline system 111. Data source 101 may comprise a computing device of an industrial system, a financial system, research system, or some other type of system configured to generate data that characterizes that system. For example, data source 101 may comprise a computer affiliated with an online transaction service that generates sales data which characterizes events performed by the online transaction service. For example, data source 101 may comprise an industrial controller that generates operational data that characterizes the operations of a machine in an automated factory environment. It should be appreciated that data source 101 is exemplary and the type of data generated by data source 101 is not limited.

Data pipeline system 111 is operatively coupled to data pipeline source 101, data target 121, and monitoring system 131. Data pipeline system 111 is representative of a data processing system which intakes “raw” or otherwise unprocessed data from data source 101 and emits processed data configured for consumption by an end user. Data pipeline system 111 comprises data pipeline 112, pipeline inputs 113, and pipeline outputs 114. Pipeline inputs 113 comprise unprocessed data sets generated by data source 101. Pipeline outputs 114 comprise processed data sets generated by the one or more data processing operations implemented by data pipeline 112. Data pipeline 112 comprises one or more computing devices that are connected in series that intake pipeline inputs 113 received from data source 101, implement one or more processing steps on pipeline inputs 113, and generate pipeline outputs 114. For example, the computing devices of data pipeline 112 may ingest pipeline inputs 113 and execute transform functions on pipeline inputs 113. The execution of the transform functions alters pipeline inputs 113 into a consumable form to generate pipeline outputs 114. For example, pipeline inputs 113 may comprise data strings of non-uniform length and data pipeline 112 may parse the strings to form pipeline outputs 114. Upon generation of pipeline outputs 114, data pipeline 112 transfers pipeline outputs to data target 121. In some examples, data pipeline system 112 may transfer pipeline outputs 114 to computing device 132 to facilitate the monitoring operations of monitoring system 131.

Data target 121 is operatively coupled to data pipeline system 111. Data target 121 is representative of one or more computing systems comprising memory that receive pipeline outputs 114 generated by data pipeline 112. Data target 121 may comprise a database, data structure, data repository, data lake, another data pipeline, and/or some other type of data storage system. In some examples, data target 121 may transfer pipeline outputs 114 received from data pipeline system 111 to monitoring system 131 to facilitate the pipeline monitoring operations of monitoring system 131. As data target 121 receives and stores pipeline outputs 114, data target 121 builds historical data sets. Data target 121 tracks the generation dates of the historical data sets. By tracking the generation dates of the historical data sets, monitoring system 131 may model past operations of pipeline 112.

Monitoring system 131 is operatively coupled to data pipeline system 111 and data target 121. Monitoring system 131 is representative of one or more computing devices configured to monitor the operation of data pipeline system 111. Monitoring system 131 ingests historical data outputs from data target 121 to model the operations of data pipeline system 111 and utilizes the models to monitor the operations of pipeline system 111. Monitoring system 131 comprises computing device 132, user interface 133, and pipeline control module 134. Computing device 132 comprises one or more computing apparatuses configured to host pipeline control module 134 and present a Guided User Interface (GUI) on user interface 133 to facilitate user interaction with module 134. Pipeline control module 134 is representative of one or more applications configured to monitor the operation of data pipeline system 111. For example, control module 134 may be representative of a collection of modules with data ingestion functionality, training functionality, and monitoring functionality. It should be appreciated that the specific number of applications and modules hosted by computing device 132 is not limited. Exemplary applications hosted by computing device 132 to monitor the operations of data pipeline system 111 include Data Culpa Validator and the like. Computing device 132 is coupled to user interface 133. User interface 133 comprises a display, keyboard, touchscreen, tablet, and/or other elements configured to provide a visual representation of, and means to interact with, pipeline control module 134. For example, user interface 133 may receive mouse inputs, trackpad inputs, keyboard inputs, touchscreen inputs, and the like to facilitate interaction between a user and pipeline control module 134. User interface 133 provides a GUI display that allows a user to interact with pipeline control module 134 and/or any other application(s) hosted by computing device 102 to generate models based on historical data to monitor the operation of data pipeline system 111.

Pipeline control module 134 is configured to model the operations of data pipeline 112 based on historical operations, monitor pipeline outputs using the models, and generate alerts when anomalous behavior of data pipeline system 111 is detected. Pipeline control module 134 comprises visual elements including output model 135, output sets 136, and alerts 137 to facilitate user interaction with module 134. Output model 135 comprises a model derived by historical pipeline outputs generated by data pipeline 112 that indicates expected pipeline outputs, inputs, and operations for pipeline system 111. For example, output model 135 may indicate expected input and output data volumes for data pipeline 112 based on observed historical operations of pipeline 112. Output sets 136 comprise data outputs generated by data pipeline 112 ingested by computing device 132. For example, pipeline system 111 may copy an output stream comprising pipeline outputs 114 and transfer the copied output stream to monitoring system 131 as output sets 136. Alerts 137 comprise a notification to indicate that a problem has occurred in data pipeline system 111. Alerts 137 comprise visual and textual information to indicate the detected problem. For example, control module 134 may determine that average data value of output sets 136 is 15% greater than the historical norm indicated by output model 135 and responsively generate alerts 137.

Data pipeline system 111, data target 121, and monitoring system 131 comprise microprocessors, software, memories, transceivers, bus circuitry, and the like. The microprocessors comprise Central Processing Units (CPUs), Graphical Processing Units (GPUs), Application-Specific Integrated Circuits (ASICs), Field Programmable Gate Arrays (FPGAs), and/or other types of processing circuitry. The memories comprise Random Access Memory (RAM), flash circuitry, Solid State Drives (SSDs), Hard Disk Drives (HDDs), Non-Volatile Memory Express (NVMe) SSDs, and/or the like. The memories store software like operating systems, user applications, training applications, data analysis applications, and data processing functions. The microprocessors retrieve the software from the memories and execute the software to drive the operation of the data processing system as described herein. The communication links that connect the elements of data processing system use metallic links, glass fibers, radio channels, or some other communication media. The communication links use Time Division Multiplex (TDM), Data Over Cable System Interface Specification (DOCSIS), Internet Protocol (IP), General Packet Radio Service Transfer Protocol (GTP), Institute of Electrical and Electron Engineers (IEEE) 802.11 (WIFI), IEEE 802.3 (ENET), virtual switching, inter-processor communication, bus interfaces, and/or some other data communication protocols. Data source 101, data pipeline system 111, data target 121, and monitoring system 131 may exist as a single computing device or may be distributed between multiple computing devices.

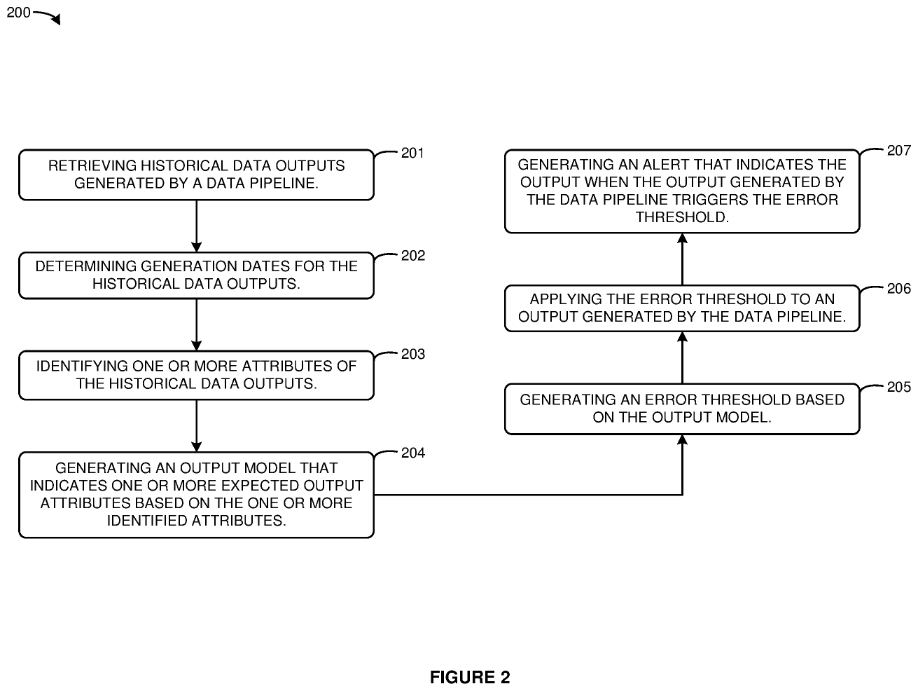

In some examples, data processing environment 100 implements process 200 illustrated in FIG. 2. It should be appreciated that the structure and operation of data processing environment 100 may differ in other examples.

FIG. 2 illustrates process 200. Process 200 comprises a process to determine expected data attributes of a data pipeline. Process 200 may be implemented in program instructions in the context of any of the software applications, module components, or other such elements of one or more computing devices. The program instructions direct the computing devices(s) to operate as follows, referred to in the singular for the sake of clarity.

The operations of process 200 comprise retrieving historical data outputs generated by a data pipeline (step 201). The operations further comprise determining generation dates for the historical data outputs (step 202). The operations further comprise identifying one or more attributes of the historical data outputs (step 203). The operations further comprise generating an output model that indicates one or more expected output attributes based on the one or more identified attributes (step 204). The operations further comprise generating an error threshold based on the output model (step 205). The operations further comprise applying the error threshold to an output generated by the date pipeline (step 206). The operations further comprise generating an alert that indicates the output when the output generated by the data pipeline triggers the error threshold (step 207).

Referring back to FIG. 1, data processing environment 100 includes a brief example of process 200 as employed by one or more applications hosted by computing device 132, data target 121, and data pipeline 112. The operation may differ in other examples.

In operation, data source 101 generates data and transfers the generated data to pipeline system 111 as pipeline inputs 113. Pipeline 112 ingests pipeline inputs 113 and executes a transform function on pipeline inputs 113 to generate pipeline outputs 114. Pipeline outputs 114 may comprises strings, integers, and/or another type of data generated by the data processing, cleaning, and/or reformatting operations of pipeline 112. Pipeline outputs 114 may comprise date fields, time stamps, cache dates, or other information indicating the date of generation for individual ones of outputs 114. Pipeline 112 transfers outputs 114 to data target 121. Data target 121 stores the received outputs in memory. Over time as pipeline 112 operates, data target 121 accumulates pipeline outputs. The accumulated pipeline outputs form a historical data catalogue that indicates the operations of data pipeline 112 over time. Data target 121 tracks the date of generation for the received outputs. For example, data target 121 may populate a database with the pipeline outputs in association with the date of generation.

Pipeline monitoring system 131 couples to data pipeline system 111 and data target 121 to monitor the operations of data pipeline 112. In response to user input received via user interface 133, computing device 132 initiates a training process to setup the pipeline monitoring functions. The user input specifies historical data sets generated by pipeline 112 and stored by data target 121. Computing device 132 executes a data ingestion module to ingest historical data outputs generated by pipeline 112 and stored by data target 121. The data ingestion module transfers a request for the user specified historical data to data target 121 (step 201). Data target 121 receives the request and responsively returns the requested historical data to computing device 132. For example, the request may indicate a date range (i.e., July 1^{st} to September 1^{st}) for the historical data and data target 121 may return historical data for the specified date range. Data target 121 may identify a date field, timestamp, cache date, or other chronological information in the historical data to identify the historical data for the requested date range. In some examples, the request may specify a data output type and data target 121 may return historical data for only that data type. For example, the request may specify strings as the data type and data target 121 may return all strings generated by pipeline 112. In some examples, the request may specify specific data sets within the historical data and data target 121 may return the requested sets. Computing device 132 receives the requested historical data sets from data target 121. The ingestion module hosted by computing device 132 determines the generation dates for the received data sets (step 202).

Computing device 132 executes a training module to build output model 135 based on the historical outputs retrieved from data target 121. In some examples, the training module may create a time-series to order the historical data and process each data output according to the time-series. The training module processes historical data to generate output model 135. Output model 135 governs expected output attributes for pipeline 112 based on the historical operations of pipeline 112. The training module identifies the data types, data values, data volumes, pipeline throughputs, structures, shapes, generation dates, and/or other data attributes for individual ones of the historical outputs (step 203). The training module may repeat this process for each of the individual data outputs to measure the queried historical data set in its entirety. The training module generates model 135 based on the identified data types, data values, data volumes, pipeline throughputs, structures, shapes, and generation dates (step 204). For example, output model 135 may comprise expected data types, average data values, average data volumes and pipeline throughputs, expected data structures, and expected data shapes in association with the generation dates.

The training module determines an error threshold for data pipeline 112 based on model 135 (step 205). The error threshold indicates acceptable ranges for the various data attributes that comprise model 135. For example, output model 135 may indicate an average data volume for a date of operation for data pipeline system 111. The training module may generate an error threshold comprising thresholds where measured data volumes that exceed the threshold trigger the generation of an alert. For example, data volumes that differ by more than 10% from the average volume indicated by model 135 may trigger the error threshold. In some examples, the error thresholds may comprise user configurable thresholds. For example, the training module may then receive a user input via user interface 133 that defines an error threshold for one or more data attributes indicated by model 135. Alternatively, the monitoring module may determine the error thresholds independent of user input. For example, model 135 may indicate average data values for outputs generated on Fridays. The monitoring circuitry may then determine an error threshold based on the average output data value for the data pipeline 112 to use when operating on a Friday.

Once the error thresholds have been determined, the computing device 132 notifies a pipeline operator that training is complete and communicatively couples to data pipeline system 111. For example, computing device 132 may display a notification on user interface 133 indicating training is complete and receive a user command to connect to pipeline system 111. Computing device 132 executes a monitoring module to apply the error thresholds to outputs generated by pipeline 112 to monitor the operations of pipeline system 111. Data pipeline receives additional input data from data source 101. Data pipeline 112 executes its data processing operations on the input data and responsively generates output data. Data pipeline 112 copies the output stream and transfers the copied output stream to monitoring system 131 as outputs 136. The monitoring module applies the error thresholds to the output data to determine if one or more attributes of outputs 136 deviate from historical data attributes indicated by model 135 (step 206). When an attribute of outputs 136 exceeds its error threshold, the monitoring module generates alert 137 to indicate the detected error (step 207). For example, the measured volumes of data outputs 136 may exceed the error threshold, and the monitoring module may responsively generate alert 137. Computing device 132 displays alert 137 on user interface 133 to notify the pipeline operator of the detected error.

Advantageously, data monitoring system 131 ingests historical data generated by pipeline system 111 and efficiently models the operation of pipeline system 111 based on the ingested historical data. Moreover, data monitoring system 131 effectively generates error thresholds based on the model to monitor the operations of pipeline system 111 to detect when pipeline system 111 deviates from historical norms.

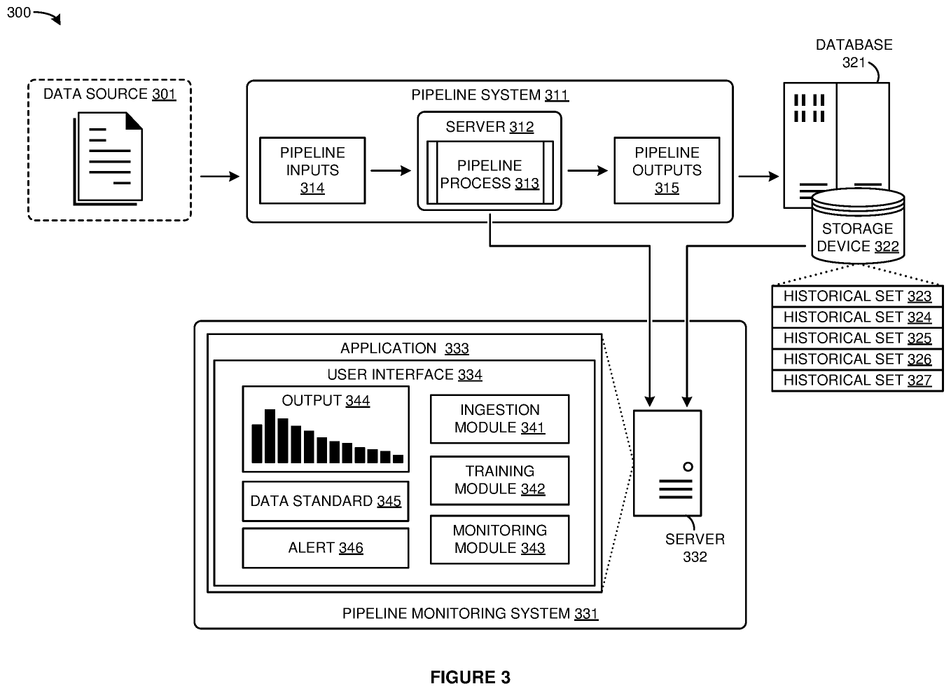

FIG. 3 illustrates data processing environment 300 to determine expected data attributes of a data pipeline. Data processing environment 300 is an example of data processing environment 100, however data processing environment 100 may differ. Data processing environment 300 comprises data source 301, pipeline system 311, database 321, and pipeline monitoring system 331. Pipeline system 311 comprises server 312, pipeline process 313, pipeline inputs 314, and pipeline outputs 315. Database 321 comprises storage device 322 and historical sets 323-327. Pipeline monitoring system 331 comprises server 332, application 333, user interface 334, ingestion module 341, training module 342, monitoring module 343, output 344, data standard 345, and alert 346. In other examples, data processing environment 300 may include fewer or additional components than those illustrated in FIG. 3. Likewise, the illustrated components of data processing environment 300 may include fewer or additional components, assets, or connections than shown. Each of data source 301, pipeline system 311, database 321, and/or pipeline monitoring system 331 may be representative of a single computing apparatus or multiple computing apparatuses.

Data source 301 is representative of one or more computing devices configured to generate input data configured for ingestion by pipeline system 311. Data source 301 may produce industrial data, financial data, scientific data, machine learning data, and/or other types of input data for consumption by data pipeline system 311. Typically, the input data generated by data source 301 is not-suitable for end user consumption (e.g., storage in database 321) and requires data processing by pipeline system 311. It should be appreciated that the types of data sources that comprise data source 301 and the input data generated by data source 301 are not limited.

Pipeline system 311 is representative of data processing devices configured to receive and process input data from data source 301 and generate output data for end user consumption. Pipeline system 311 comprises one or more computing devices integrated into a network that communicates with data source 301 and database 321, and pipeline monitoring system 331. Examples of pipeline system 311 may include server computers and data storage devices deployed on-premises, in the cloud, in a hybrid cloud, or elsewhere, by service providers such as enterprises, organizations, individuals, and the like. Pipeline system 311 may rely on the physical connections provided by one or more other network providers such as transit network providers, Internet backbone providers, and the like to communicate with data source 301, database 321, and/or pipeline monitoring system 331.

Pipeline system 311 comprises server computer 312 which hosts pipeline process 313. Server computer 312 comprises processors, bus circuitry, storage devices, software, and the like configured to host pipeline process 313. The processors may comprise CPUs, GPUs, ASICs, FPGAs, and the like. The storage devices comprise flash circuitry, RAM, HDDs, SSDs, NVMe SSDs, and the like. The storage devices store the software (e.g., pipeline process 313). The processors may retrieve and execute software stored on the storage devices to drive the operation of pipeline system 311.

Server computer 312 hosts pipeline process 313. Pipeline process 313 comprises a series of processing algorithms configured to transform pipeline inputs 314 into pipeline outputs 315. The data processing algorithms may comprise one or more transform functions arranged in series and configured to operate on pipeline inputs 314. The transform functions may be executed by the processors of server 312 on pipeline inputs 314 and responsively generate pipeline outputs 315. Pipeline inputs 314 comprise data generated by data source 301. Pipeline outputs 315 comprise data emitted by pipeline process 313. Pipeline process 313 may comprise a data cleaning process that transforms pipeline inputs 314 into pipeline outputs 315 suitable for storage in database 321. The cleaning process may comprise reformatting, redundancy removal, or some other type of operation to standardize pipeline inputs 314. It should be appreciated that pipeline process 313 is exemplary and the specific data processing operations implemented by pipeline process 313 are not limited.

In some examples, pipeline process 313 may comprise a machine learning model where pipeline inputs 314 represent machine learning inputs and pipeline outputs 315 represent machine learning outputs. The machine learning model may comprise one or more machine learning algorithms trained to implement a desired process. Some examples of machine learning algorithms include artificial neural networks, nearest neighbor methods, ensemble random forests, support vector machines, naïve Bayes methods, linear regressions, or other types of machine learning algorithms that predict output data based on input data. In this example, pipeline inputs 314 may comprise feature vectors configured for ingestion by one or more machine learning algorithms and pipeline outputs 315 may comprise machine learning decisions.

Database 321 comprises storage device 322 and is representative of a data target for pipeline process 313. Database 321 comprises processors, bus circuitry, storage devices (including storage device 322), software, and the like configured to store output data sets 323-325. The processors may comprise CPUs, GPUs, ASICs, FPGAs, and the like. The storage devices comprise flash drives, RAM, HDDs, SSDs, NVMe SSDs, and the like. The processors may retrieve and execute software stored upon the storage devices to drive the operation of database 321. Database 321 receives and stores pipeline outputs 315 from pipeline process 313 on storage device 322. Over time, the received data forms historical data sets 323-327. Storage device 322 may implement a data structure that categorizes and organizes pipeline outputs 315 according to a data storage scheme. For example, historical sets 323-327 may be organized by data type, size, point of origin, date of generation, and/or any other suitable data storage scheme. Database 321 may comprise user interface systems like displays, keyboards, touchscreens, and the like that allows a human operator to view and interact with historical sets 323-327 stored upon storage device 322. The user interface systems may allow a human operator to review, select, and transfer ones of historical sets 323-327 to pipeline monitoring system 331.

Pipeline monitoring system 331 is representative of one or more computing devices integrated into a network configured to monitor the operation of pipeline system 311. Pipeline monitoring system 331 comprises server computer 332. Server computer 332 comprises one or more computing devices configured to host application 333. Server 332 is communicatively coupled to server 312 and database 321. The one or more computing devices that comprise server 332 comprise processors, bus circuitry, storage devices, software, and the like. The processors may comprise CPUs, GPUs, ASICs, FPGAs, and the like. The storage devices comprise flash drives, RAM, HDDs, SSDs, NVMe SSDs, and the like. The storage devices store the software (e.g., application 333). The processors may retrieve and execute software stored on the storage devices to drive the operation of monitoring system 331.

Application 333 is representative of one or more pipeline monitoring applications, training applications, user interface applications, operating systems, modules, and the like. Application 333 is an example of pipeline control module 134, however pipeline control module 134 may differ. Application 333 is configured to ingest historical output sets 323-327 to model the operations of pipeline system 311 and to monitor the operations of pipeline system 311 based on the modeled historical data. Application 333 may implement ingestion module 341, training module 342, and monitoring module 343. In some examples, application 333 is displayed as a Graphical User Interface (GUI) on user interface 334.

User interface 334 is representative of one or more display devices that provide the GUI of application 333. The graphical representation on user interface 334 includes ingestion module 341, training module 342, monitoring module 343, output 344, data standard 345, and alert 346. In other examples, the graphical representation may include additional or different types of visual indicators relevant to the training state of application 333 and to the operation and status of pipeline system 311. User interface 334 may include a computer, a display, a mobile device, a touchscreen device, or some other type of computing device capable of performing the user interface functions described herein. A user may interact with application 333 via user interface 334 to generate, view, and interact with modules 341-343, output 344, data standard 345, and alert 346.

Modules 341-343 comprise user selectable options to initiate data ingestion from storage device 322, train application 333 to monitor pipeline system 311, and to monitor the operations of pipeline system 311. Output 344 comprises a visual representation of pipeline outputs received from server 312. In this example, the visual representation that comprises output 344 comprises a histogram that categorize various attributes of the pipeline output. However, in other examples the visual representations may comprise probability distributions, data volumes, lineage charts, or other types of visual representations to characterize pipeline outputs received from server 312. The histograms may characterize data values, null value rates, zero value rates, and the like. Data standard 345 comprises an implicitly defined ruleset based on the data attributes of historical sets 323-327. Training module 342 may process historical sets 323-327 and generate data standard 345. Data standard 345 defines acceptable ranges for data types, data values, data volumes, pipeline throughputs, structures, and shapes. The acceptable ranges may be associated with dates, days of the week, or other time periods. For example, data standard 345 may comprise a first acceptable data value range for a first month and a second acceptable data value range for a second month to account for operational changes in pipeline system 311 (e.g., data volumes through pipeline system 311 may be higher or lower at different points in a year). Alert 346 comprises a notification that indicates when one or more attributes of output 344 exceeds data standard 345. The notification may comprise visual and textual information to specifically indicate which data attributes (e.g., data value ranges) violated data standard 345.

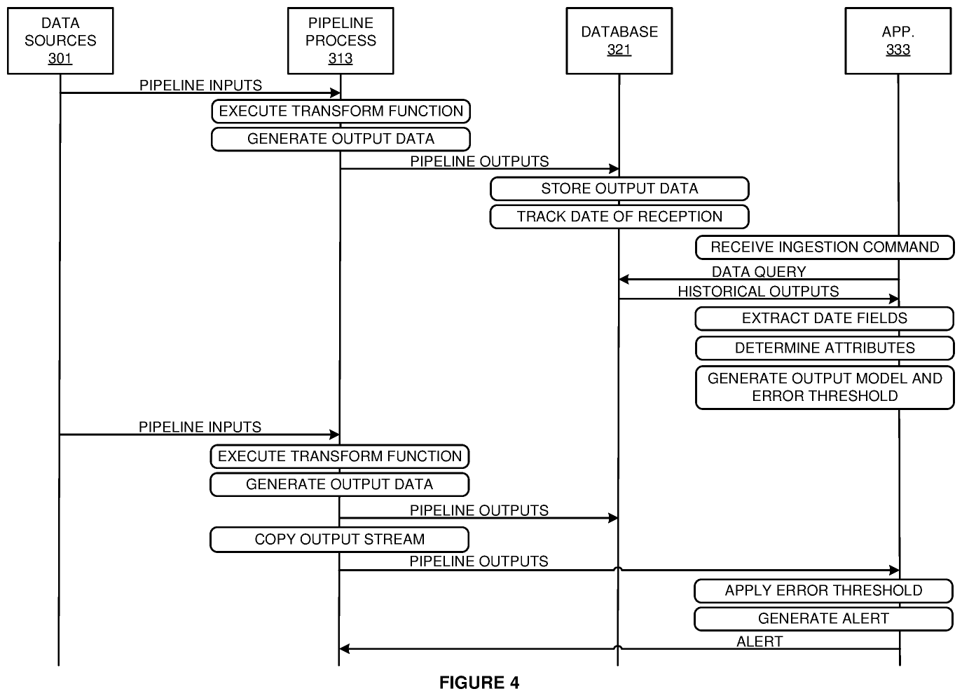

FIG. 4 illustrates an exemplary operation of data processing environment 300 to maintain data consistency in a data pipeline. The operation depicted by Figured 4 comprises an example of process 200 illustrated in FIG. 2, however process 200 may differ. In other examples, the structure and operation of data processing environment 300 may be different.

In operation, data source 301 transfer unprocessed data to data pipeline 312. For example, data source 301 may generate user subscription data and transfer the user subscription data to pipeline system 311 for processing. Pipeline system 311 receives the unprocessed data as pipeline inputs 314. Server 312 ingests pipeline inputs 314 and implements pipeline process 313. Pipeline process 313 cleans, transforms, applies a schema, or otherwise processes pipeline inputs 314 into a consumable form to generate pipeline outputs 315. Pipeline process 313 generates pipeline outputs 314 and drives transceiver circuitry in server 312 to transfer outputs 314 for delivery to database 321. Server 312 transfers pipeline outputs 315 for delivery to database 321. Database 321 receives pipeline outputs 315, stores the output data in storage device 322, and tracks the date of generation for the received output sets. Data source 301, pipeline process 313, and database 321 continue this process to generate and store historical sets 323-327. Historical sets 323-327 characterize the past operations of pipeline system 311 through time.

Subsequently, application 333 hosted by computing device 332 initiates a training process to monitor the operations of pipeline system 311. Application 333 activates ingestion module 341. Ingestion module 341 receives a command via user interface 334 to ingest historical sets 323-327. For example, a user may input the name, location, a date range, or other information into ingestion module 341 via user interface 334 and module 341 may responsively transfer a data request to database 321 for historical sets 323-327. Database 321 returns historical sets 323-327 to ingestion module 341. Ingestion module 341 extracts date fields from sets 323-327 to determine the generation dates of the pipeline outputs that comprise historical sets 323-327.

Application 333 activates training module 342 to process the ingested sets and generate data standard 345. Training module 342 assigns historical sets 323-327 to data bins based on the extracted generation dates and sequentially processes historical sets 323-327. Training module 342 determines data attributes characterizing historical sets 323-327 like value distributions, data values, averages size, value probability distributions, dates of generation, data types, data schemas, data set shapes, and the like. Training module 342 tracks the measured attributions in association with the generation dates of sets 323-327 to determine how the operation of pipeline system 311 changes over time. Typically, data values, data volumes, and/or other data attributes of outputs 315 vary depending on the day of the week, month, or time of year. For example, average data volume for outputs 315 may be higher on Friday than on Monday. Training module 342 generates data standard 345 based on the identified attributes of historical sets 323-327. For example, training module 342 may average the measured attributes of historical sets 323-327 and may use the averaged attributes to generate standard 345. In some examples, training module 342 generates individual models for each of sets 323-327 based on their measured attributes and combines the individual models to form data standard 345. In some examples, training module 342 groups sets 323-327 by generation date and models ones of sets 323-327 that share generation date characteristics. For example, training module 342 may determine set 323 and set 327 we both generated on Fridays and responsively generate an individual model for sets 323 and 327. In any case, data standard 345 indicates preferred data formats for outputs generated by pipeline system 311. In some examples, data standard 345 indicates expected changes between data sets generated at different dates. For example, data standard 345 may comprise expected increases, or decreases between outputs generated over time.

Training module 342 comprises user configurable options to set error thresholds for the modeled data attributes that comprise standard 345. The user configurable options may comprise slider bars, text input options, and the like. Training module 342 receives user inputs via interface 334 that sets the error thresholds. The user defined error thresholds may vary between data attributes and/or time periods. For example, the error threshold for data volume may allow for a 5% deviation from the expected data volume indicated by standard 345 while the error threshold for data value distribution may allow for a 10% deviation from the expected data value distribution indicated by standard 345. For example, the error threshold for data volume may allow for a 5% deviation from the expected data volume indicated by standard 345 during weekdays while the error threshold for data volume may allow for a 10% deviation from the expected data value distribution indicated by standard 345 during weekends. Once the error thresholds are set, application 333 displays data standard 345 on user interface 334 and activates monitoring application 343. Application 333 connects to data pipeline system 311 and notifies pipeline system 311 that training is complete.

Data source 301 transfers additional unprocessed data to data pipeline 312. Pipeline system 311 receives the additional unprocessed data as pipeline inputs 314. Server 312 ingests pipeline inputs 314 and implements pipeline process 313. Pipeline process 313 executes a transform function on inputs 314 to generate pipeline outputs 315. Pipeline process 313 generates pipeline outputs 314 and drives transceiver circuitry in server 312 to transfer outputs 314 for delivery to database 321. Server 312 transfers pipeline outputs 315 for delivery to database 321. Database 321 receives pipeline outputs 315, stores the output data in storage device 322. Server 312 copies the pipeline output stream and transfers the copied stream for delivery to monitoring system 331. For example, server 312 may transfer an Application Programming Interface (API) call to an API hosted by computing system 332 to ingest the copied output data stream.

Computing device 332 ingests the copied output data stream as output 344. Monitoring module 343 determines the value distributions, data values, averages size, value probability distributions, dates of generation, data types, data schemas, data set shapes, and/or other attributes for output 344. Monitoring module 343 compares the measured data attributes of output 344 to the expected attributes indicated by data standard 345 to determine any differences between the measured and expected attributes. Monitoring module 343 applies the user defined error thresholds to the differences. When the magnitude of the difference exceeds the error threshold, monitoring module 343 generates alert 346. Alert 346 comprises textual and visual information to indicate one of more of the attributes of output 344 that exceeded the threshold. Application 333 displays alert 346 on user interface 334. Application 333 additionally transfers alert to pipeline system 311 to notify pipeline operators.

In some examples, application 333 may apply the error thresholds to historical sets 323-237 used for training monitoring 331. In doing so, application 333 may determine the number of alerts that would have occurred had the error threshold been in use during the previous operation of data pipeline system 311. Application 333 may generate a report indicating the error rate of data pipeline process 313 and display the report on user interface 334.

In some examples, application 333 may determine the historical data retrieved from database 321 is incomplete. For example, application 333 make request historical data for a given period of time and may receive historical data that only covers 90% of the requested period of time. In this case, application 333 may infer the missing sections of the historical data to generate a complete data set. For example, application 333 may interpolate between known entries in the historical data set to model missing sections of the historical data set. It should be noted that the exact method to model the missing sections of the historical data is not limited. Application 333 may label the portions of the historical data that it generated to distinguish the modelled data from the received historical data.

In some examples, the historical data received by application 333 may be partial and application 333 may receive additional historical data at a later time period. In such cases, application 333 may add the additional historical data to the historical data set. Application 333 may process the updated set as described above and update data standard 345 accordingly.

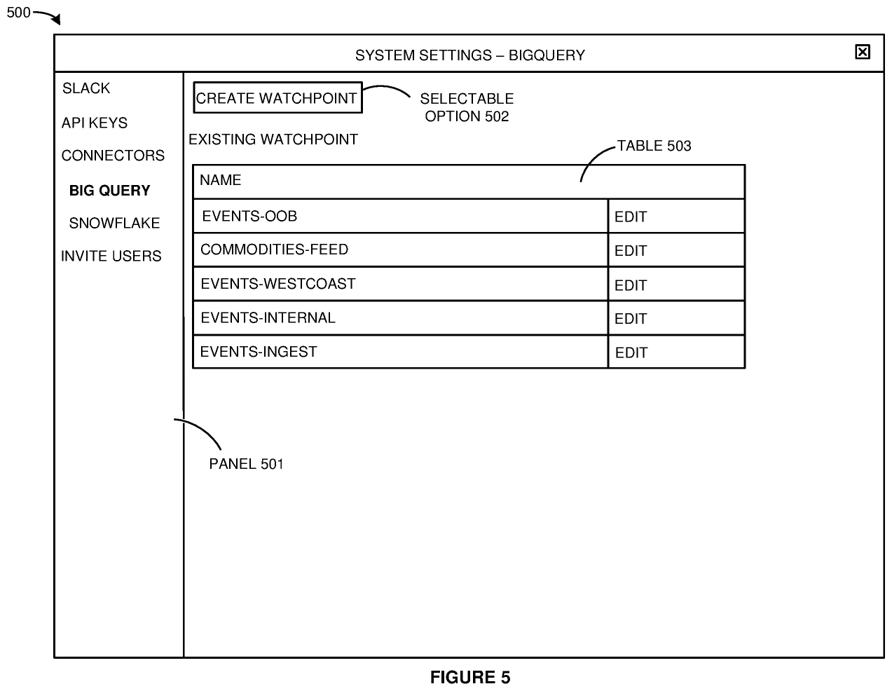

FIG. 5 illustrates user interface 500 to train a data pipeline monitoring system to detect errors in a data pipeline. User interface 500 comprises an example of user interface 133 and user interface 334, however user interface 133 and user interface 334 may differ. User interface 500 allows a user to initiate a training process for the data pipeline monitoring system. User interface 500 comprises panel 501, selectable option 502, and table 503.

Panel 501 comprises a set of selectable categories that allow a user to access different functionalities of user interface 500. The selectable categories are labeled slack, API keys, connectors, big query, snowflake, and invite users. In this example, a user has selected the big query option. The big query option is an example of a data set selection option and may be used to select data sets for the data pipeline monitoring application to ingest and process. Upon the selection of the big query option, user interface 500 displays selectable option 502 and table 503.

Table 503 comprises a list of existing datasets, labeled watchpoints in FIG. 5, the pipeline monitoring system currently monitors. Table 503 comprises lists exemplary datasets labeled events-oob, commodities-feed, events-westcoast, events-internal, and events-ingest. Table 503 additionally comprises selectable options to edit the listed datasets. For example, a user may select the edit option that corresponds to the dataset labeled events-oob to edit the name, change the monitoring schedule, cancel monitoring, or perform some other operation related to the dataset.

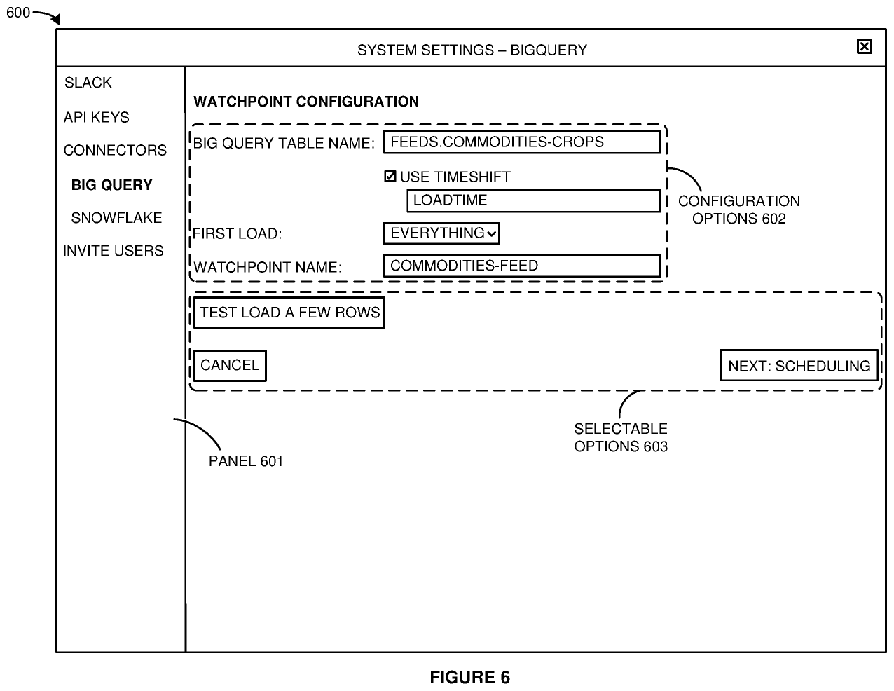

Selectable option 502 is labeled create watchpoint and comprises an option to select a new dataset for the pipeline monitoring system to monitor. For example, a user may wish to train the pipeline monitoring system to monitor a new data output produced by a corresponding data pipeline. The user may select selectable option 502 via a mouse click, a touchscreen, a keystroke, and/or some other type of user interface command. In some examples, the selection of selectable option 502 drives the computing device that displays user interface 500 to display user interface 600 illustrated in FIG. 6.

FIG. 6 illustrates user interface 600 to train a data pipeline monitoring system to detect errors in a data pipeline. User interface 600 comprises an example of user interface 133 and user interface 334, however user interface 133 and user interface 334 may differ. User interface 600 allows a user to configure a training process for the data pipeline monitoring system. A user may interact with user interface 600 to select a set of training data to train the data pipeline monitoring system, select the time period that the data was generated on, and to label the dataset. User interface 600 comprises panel 601, configuration options 602, and selectable options 603.

Panel 601 comprises a set of selectable categories that allow a user to access different functionalities of user interface 600. The selectable categories are labeled slack, API keys, connectors, big query, snowflake, and invite users. In this example, a user has selected the big query option. The big query option is an example of a data set selection option and may be used to select data sets for the data pipeline monitoring application to ingest and process.

Configuration options 602 comprise options to select datasets to import, to select generation times for the dataset, to label the imported dataset, and to configure the proportion of the selected dataset to import. The option labeled big query table name comprises an input box that allows user to select a dataset. The input box may comprise a drop-down menu that, upon selection, expands to list a set of available datasets. Alternatively, the input box may allow a user to input text and type in the name of the dataset to input. The option labeled use timeshift allows a user to import historical data of the selected dataset. The option labeled loadtime allows a user to select a time range (e.g., July 1^{st} to September 1^{st}) for the historical data. The option labeled first load allows a user to configure the proportion of the selected data set to import. In this example, a user has selected to import the entire dataset however in other examples, a user may import less than the entire set. The option labeled watchpoint name allows the user to select a name for the dataset once imported by the pipeline monitoring system.

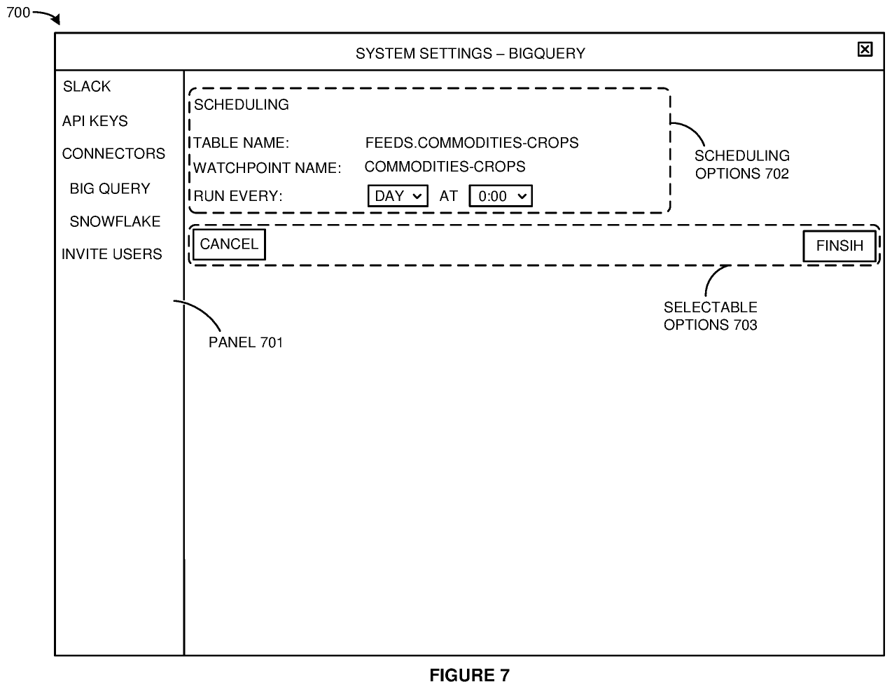

Selectable options 603 comprise selectable options to cancel the training operation, schedule the training operations, and test load the data set. The option to test load the data set may be used to test the integrity of the data set and/or the connection with the database that stores the data set. For example, a user may test load a few rows the selected dataset to identify if the dataset is populated with the data of interest. In some examples, the selection of selectable option labeled cancel drives the computing device that displays user interface 600 to display user interface 500 illustrated in FIG. 5. In some examples, the selection of selectable option labeled scheduling drives the computing device that displays user interface 600 to display user interface 700 illustrated in FIG. 7.

FIG. 7 illustrates user interface 700 to train a data pipeline monitoring system to detect errors in a data pipeline. User interface 700 comprises an example of user interface 133 and user interface 334, however user interface 133 and user interface 334 may differ. User interface 700 allows a user to schedule a training process for the data pipeline monitoring system. A user may interact with user interface 700 to select a time to import a set of training data to train the data pipeline monitoring system and to initiate the import of the training data. User interface 700 comprises panel 701, scheduling options 702, and selectable options 703.

Panel 701 comprises a set of selectable categories that allow a user to access different functionalities of user interface 700. The selectable categories are labeled slack, API keys, connectors, big query, snowflake, and invite users. In this example, a user has selected the big query option. The big query option is an example of a data set selection option and may be used to select data sets for the data pipeline monitoring application to ingest and process.

Scheduling options 702 lists the name of the dataset to be imported and the watchpoint label for the dataset for training. Scheduling options 702 comprises selectable options to select a date and time to import and process the selected training data. The selectable options may comprise drop down menus. For example, a user may select the option labeled day, the option may open and list a set of available dates to schedule the import of the data set.

Selectable options 703 comprise selectable options to cancel the training operation and finish the configuration and scheduling of the training operation. In some examples, the selection of selectable option labeled cancel drives the computing device that displays user interface 700 to display user interface 500 illustrated in FIG. 5. In some examples, the selection of selectable option labeled finish drives the computing device to direct the pipeline monitoring system to ingest the selected training dataset at the scheduled time.

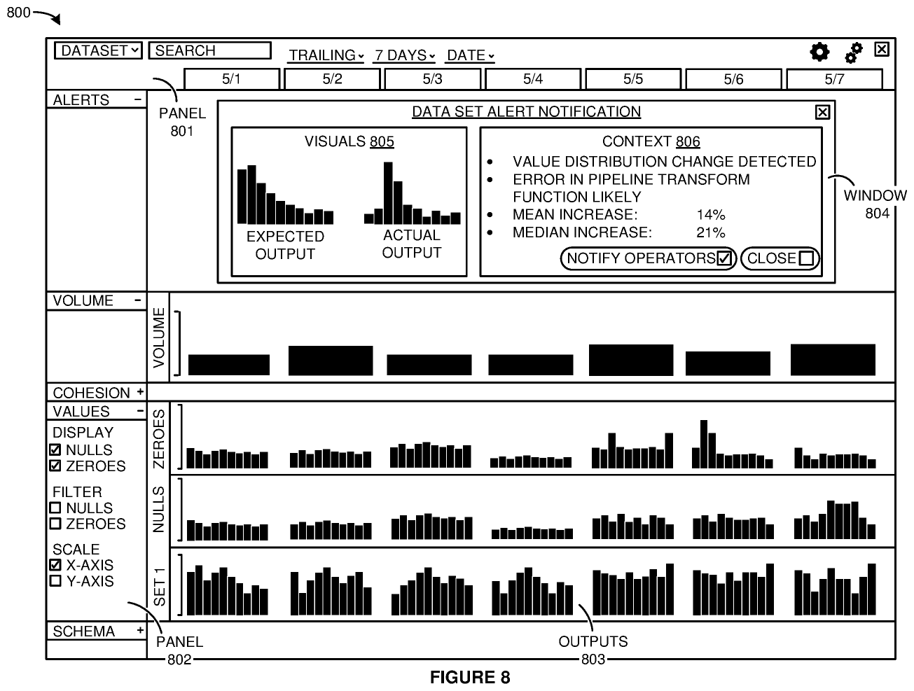

FIG. 8 illustrates user interface 800 to monitor the operations of a data pipeline. User interface 800 comprises an example of user interface 133 and user interface 334, however user interface 133 and user interface 334 may differ. User interface 800 comprises a pipeline monitoring application presented on a display screen which is representative of any user interface for indicating when errors occur in a data pipeline. User interface 800 comprises a GUI configured to allow a user to view operational metrics for a data pipeline like data volume and data shape and to receive notifications regarding detected errors in the operations of the data pipeline. The GUI provides visualizations for how data set volume, data set values, data set zero values, and data set null values change over time. In other examples, the GUI of user interface 800 may differ.

User interface 800 includes panel 801. Panel 801 is representative of a navigation panel and comprises tabs like “dataset” and “search” that allows a user to find and import data sets into user interface 800. For example, a user may interact with the “dataset” tab to import a data set from a data storage system that receives the outputs of the pipeline. Panel 801 also includes date range options to select data sets a data set from a period of time. In this example, a user has selected to view a data set over a week ranging from May 1^{st} to May 7^{th} labeled as 5/1-5/7 in user interface 800. In other examples, a user may select a different date range and/or a different number of days.

User interface 800 includes panel 802. Panel 802 comprises tabs labeled alerts, volume, cohesion, values, and schema. In other examples, panel 802 may comprise different tabs than illustrated in FIG. 8. When a user selects one of the tabs, the tab expands to reveal its contents. In this example, a user has opened the values tab, the volume tab, and the alerts tab. The values tab and the volume tab comprise outputs 803. The values tab also includes display options to modify the view of outputs 803. The display options include toggles labeled nulls, zeroes, zeroes or nulls, x-axis, and y-axis. In other examples, the display options may differ. The alerts tab comprises window 804.

User interface 800 includes outputs 803. Outputs 803 comprises histogram visualizations, bar graph visualizations, and/or other types of visualizations of data sets imported into user interface 800. In this example, outputs 803 include volume, zeroes, nulls, and set 1. Each set of outputs 803 corresponds to the date selected by a user in panel 801. For example, the zeroes data set of outputs 803 is presented as a row with each portion of the set corresponding to the dates presented in panel 801. Outputs 803 allow a user to view the shape, value distribution, size, and/or other attributes of the imported data sets. The zeroes set of outputs 803 comprise histograms that characterize the number of zero values for the data fields that comprise outputs of a data pipeline. The nulls set of outputs 803 comprise histograms that characterize the number of null fields for the data sets that comprise outputs of a data pipeline. The volume set of outputs 803 indicates the data volume output by the data pipeline. The set 1 set of outputs 803 comprise histograms that characterize the value distributions for the data fields that comprise outputs of a data pipeline. In other examples, outputs 803 may comprise different types of data sets than those illustrated in FIG. 8.

User interface 800 includes window 804. Window 804 is representative of an alert to notify a user that an error occurred in a data pipeline. For example, the data pipeline monitoring system may apply error thresholds derived from the historical operation of the data pipeline to outputs 803 and generate window 804 when one or more of outputs 803 trigger one or more of the error thresholds. Window 804 comprises visuals 805 and context 806. In should be appreciated that window 804 is exemplary and may differ in other examples. Visuals 805 comprises an animated visualization that depicts how one of outputs 803 differs from an expected output to visually depict why the alert was triggered. Visuals 805 illustrates an expected output and an actual output of outputs 803. The expected output may be derived based on a data standard derived based on the historical operation of the data pipeline. Context 806 comprises textual information to characterize the detected error in the data pipeline. In this example, context 806 indicates the value distribution in the selected set has changed and that the change was caused by an error in the pipeline transform function. Context 806 additionally indicates the data mean increased by 14% and the data median value increased by 21%. Window 804 comprises user selectable options to respond to the detected error. In this example, the selectable options comprise an option to notify operators or to close the alert. In this example, a user has selected the option to notify operators. It should be appreciated that the information and user selectable options depicted in context 806 are exemplary and may differ in other examples.

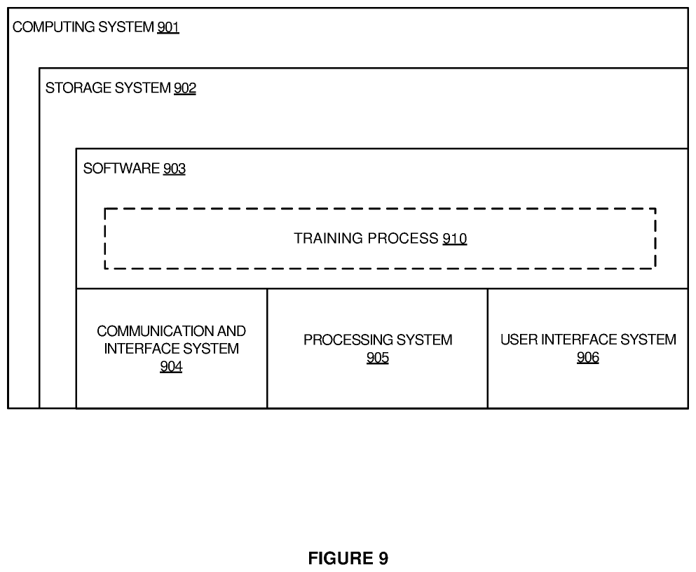

FIG. 9 illustrates computing device 901 which is representative of any system or collection of systems in which the various processes, programs, services, and scenarios disclosed herein for to alert when errors occur in data pipelines within data processing environments may be implemented. For example, computing device 901 may be representative of data pipeline system 111, data target 121, computing device 132, pipeline system 311, database 321, server 332, and/or user interfaces 500-800. Examples of computing system 901 include, but are not limited to, server computers, routers, web servers, cloud computing platforms, and data center equipment, as well as any other type of physical or virtual server machine, physical or virtual router, container, and any variation or combination thereof.

Computing system 901 may be implemented as a single apparatus, system, or device or may be implemented in a distributed manner as multiple apparatuses, systems, or devices. Computing system 901 includes, but is not limited to, storage system 902, software 903, communication and interface system 904, processing system 905, and user interface system 906. Processing system 905 is operatively coupled with storage system 902, communication interface system 904, and user interface system 906.

Processing system 905 loads and executes software 903 from storage system 902. Software 903 includes and implements training process 910, which is representative of the processes to train a data pipeline monitoring system based on historical data and to detect errors in data pipelines. For example, training process 910 may be representative of process 200 illustrated in FIG. 2 and/or the exemplary operation of environment 300 illustrated in FIG. 4. When executed by processing system 905, software 903 directs processing system 905 to operate as described herein for at least the various processes, operational scenarios, and sequences discussed in the foregoing implementations. Computing system 901 may optionally include additional devices, features, or functionality not discussed here for purposes of brevity.

Processing system 905 may comprise a micro-processor and other circuitry that retrieves and executes software 903 from storage system 902. Processing system 905 may be implemented within a single processing device but may also be distributed across multiple processing devices or sub-systems that cooperate in executing program instructions. Examples of processing system 905 include general purpose central processing units, graphical processing units, application specific processors, and logic devices, as well as any other type of processing device, combinations, or variations thereof.

Storage system 902 may comprise any computer readable storage media that is readable by processing system 905 and capable of storing software 903. Storage system 902 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 902 may also include computer readable communication media over which at least some of software 903 may be communicated internally or externally. Storage system 902 may be implemented as a single storage device but may also be implemented across multiple storage devices or sub-systems co-located or distributed relative to each other. Storage system 902 may comprise additional elements, such as a controller, capable of communicating with processing system 905 or possibly other systems.

Software 903 (training process 910) may be implemented in program instructions and among other functions may, when executed by processing system 905, direct processing system 905 to operate as described with respect to the various operational scenarios, sequences, and processes illustrated herein. For example, software 903 may include program instructions for ingesting historical data generated by a data pipeline, modeling the historical operation of the data pipeline based on the ingested data, and generating an alert when outputs received from the data pipeline trigger error thresholds from the model as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 903 may include additional processes, programs, or components, such as operating system software, virtualization software, or other application software. Software 903 may also comprise firmware or some other form of machine-readable processing instructions executable by processing system 905.

In general, software 903 may, when loaded into processing system 905 and executed, transform a suitable apparatus, system, or device (of which computing system 901 is representative) overall from a general-purpose computing system into a special-purpose computing system customized to train a data pipeline monitoring system to detect errors in a data pipeline as described herein. Indeed, encoding software 903 on storage system 902 may transform the physical structure of storage system 902. The specific transformation of the physical structure may depend on various factors in different implementations of this description. Examples of such factors may include, but are not limited to, the technology used to implement the storage media of storage system 902 and whether the computer-storage media are characterized as primary or secondary storage, as well as other factors.

For example, if the computer readable storage media are implemented as semiconductor-based memory, software 903 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 904 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices to model historical operations of a data pipeline to detect errors in a data pipeline, it should be understood that the systems and methods described herein are not limited to such embodiments and may apply to a variety of other extension implementation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A data pipeline monitoring system to determine output attributes of a data pipeline, the system comprising:
a memory that stores executable components; and
a processor, operatively coupled to the memory, that executes the executable components, the executable components comprising:
a data ingestion component that:
retrieves historical data outputs generated by the data pipeline; and
determines generation dates for the historical data outputs;
a training component that:
identifies one or more attributes of the historical data outputs; and
generates an output model that indicates one or more expected output attributes based on the one or more identified attributes of the historical data outputs;
generates an error threshold based on the output model; and
a monitoring component that:
applies the error threshold to an output generated by the data pipeline; and
generates an alert when the output generated by the data pipeline triggers the error threshold.

2. The system of claim 1 wherein the monitoring component further:
applies the error threshold to the historical data outputs;
determines an amount of errors present in the historical data outputs; and
generates a historical error report that indicates the amount of errors present in the historical data outputs.

3. The system of claim 1 wherein the training component further:
processes each of the historical data outputs;
generates individual models for each of the historical data outputs; and
generates the output model of the historical data set based on the individual models for each of the historical data outputs and the generation dates.

4. The system of claim 1 wherein the ingestion component further:
receives a user request that specifies the historical data outputs; and
retrieves the historical data outputs generated by the data pipeline based on the user request.

5. The system of claim 1 wherein the historical data outputs indicate historical behavior of the data pipeline.

6. The system of claim 1 wherein the data pipeline comprises at least one of a data storage system or a data lake system.

7. The system of claim 1 wherein the error threshold comprises a range of allowable data characteristics.

8. A method of operating a data pipeline monitoring system to determine output attributes of a data pipeline, the method comprising:
retrieving historical data outputs generated by the data pipeline and determining generation dates for the historical data outputs;
identifying one or more attributes of the historical data outputs, generating an output model that indicates one or more expected output attributes based on the one or more identified attributes, and generating an error threshold based on the output model; and
applying the error threshold to an output generated by the data pipeline and generating an alert when the output generated by the data pipeline triggers the error threshold.

9. The method of claim 8 further comprising:
applying the error threshold to the historical data outputs;
determining an amount of errors present in the historical data outputs; and
generating a historical error report that indicates the amount of errors present in the historical data outputs.

10. The method of claim 8 further comprising:
processing each of the historical data outputs;
generating individual models for each of the historical data outputs; and
generating the output model of the historical data set based on the individual models for each of the historical data outputs and the generation dates.

11. The method of claim 8 further comprising receiving a user request that specifies the historical data outputs and retrieving the historical data outputs generated by the data pipeline based on the user request.

12. The method of claim 8 wherein the historical data outputs indicate historical behavior of the data pipeline.

13. The method of claim 8 wherein the data pipeline comprises at least one of a data storage system or a data lake system.

14. The method of claim 8 wherein the error threshold comprises a range of allowable data characteristics.

15. A non-transitory computer-readable medium storing instructions to determine output attributes of a data pipeline, wherein the instructions, in response to execution by one or more processors, cause the one or more processors to drive a system to perform operations comprising:
retrieving historical data outputs generated by the data pipeline;
determining generation dates for the historical data outputs;
identifying one or more attributes of the historical data outputs;
generating an output model that indicates one or more expected output attributes based on the one or more identified attributes;
generating an error threshold based on the output model;
applying the error threshold to an output generated by the data pipeline; and
generating an alert when the output generated by the data pipeline triggers the error threshold.

16. The non-transitory computer-readable medium of claim 15, the operations further comprising:
applying the error threshold to the historical data outputs;
determining an amount of errors present in the historical data outputs; and
generating a historical error report that indicates the amount of errors present in the historical data outputs.

17. The non-transitory computer-readable medium of claim 15, the operations further comprising:
processing each of the historical data outputs;
generating individual models for each of the historical data outputs; and
generating the output model of the historical data set based on the individual models for each of historical the data outputs and the generation dates.

18. The non-transitory computer-readable medium of claim 15, the operations further comprising:
receiving a user request that specifies the historical data outputs; and
retrieving the historical data outputs generated by the data pipeline based on the user request.

19. The non-transitory computer-readable medium of claim 15 wherein the historical data outputs indicate historical behavior of the data pipeline.

20. The non-transitory computer-readable medium of claim 15 wherein the error threshold comprises a range of allowable data characteristics.
